(19) United States
(12) Patent Application Publication
(10) Pub. No.: US 2007/0116869 A1
(43) Pub. Date: May 24, 2007

(54) Coating method to apply a layer of nano-particles absorbed on submicron ceramic oxide particles

(75) Inventors: Wen-Cheng J. Wei, Taipei (TW); Chuin-Shan Chen, Taipei (TW); Bang-Ying Yu, Taipei (TW); Jenn-Feng Li, Taipei (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: National Taiwan University

(21) Appl. No.: 11/338,674

(22) Filed: Jan. 25, 2006

(30) Foreign Application Priority Data
Nov. 23, 2005 (TW) 094141066

(51) Int. Cl. B05D 7/00; B05D 3/02

(52) U.S. Cl. 427/212; 427/372.2

(57) ABSTRACT

This invention discloses a coating method to apply a layer of nano-particles adsorbed on submicron ceramic oxide particles, which can prevent the agglomeration of nano-particles by the effects of Brownian motion and van der Waals force. Using this method, nano-sized titania can be uniformly coated on the surface of silica. This method is conducted in an aqueous solution and able to fabricate a coating layer in a controlled thickness between 5 to tens nm. After calcination, the coated particles can be assembled to form a photonic bandgap crystal. This invention also discloses a coating method to apply a uniform nano TiO₂-coating layer on the SiO₂ photonic bandgap crystals.

### BACKGROUND OF THE INVENTION

1. Field of the Invention

The present invention relates to a nano-sized layer coated on the surface of photonic bandgap crystals composed of tiny (submicron) particles and its method, more particularly to a nano-sized layer coated on the surface of photonic bandgap crystals composed of tiny particles and its method that can coat nano-sized titania particles uniformly on the surface of silica particles, and prevent an agglomeration of nano-particles by the effects of Brownian motion and van der Waals force, so as to control the nano-particles adsorbed on the coated layer of submicron ceramic oxide particles.

2. Description of the Related Art

Photonic bandgap crystals are submicron silica particles, or dielectric ceramic particles, or polymer spheres that form a three-dimensional periodic structure. Due to the specific dielectric property of the materials contained in this structure, interference or increasing/decreasing effects of incident light will be produced, when a light is projected onto the crystal with the transparent element. With manipulation of the lights, the light filtering and laser effects can be achieved. The photonic bandgap crystals are important active components and passive components of the future optical circuitry. The photonic bandgap crystals will have a light filtering function when the photonic bandgap crystals are used as passive components. As to the function of the active components, the electro-luminescence laser effect emits designed light waves, and thus a light signal source can be formed in an optical circuitry.

The photonic bandgap crystal comprises silica and other dielectric submicron spheres, and these spheres must be mono-size particles. In the past, Stöber synthesis method was used to synthesize the mono-size silica particles (Refer to “Preparation and Analysis of Dioxide Photonic Bandgap Crystals” by Chen, Ting-Wei, Mater Thesis of Department of Material Science and Engineering of National Taiwan University, June, 2002), which is a well-know prior art method. Stöber et al. adopted a sol-precipitation method and used tetra-ethyl orthosilicate (TEOS), alcohol, and ammonia hydroxide to composite mono-size silica particles, and the related technology has been disclosed in “Controlled growth of mono-disperse silica spheres in the micron size range,” by W. Stöber and A. Fink, J. Colloidal Interface Science, 26, 62-69 (1968), and the mono-size silica particle is called “Stöber silica”. Similarly, we can use similar methods to synthesize titania particles. Since the rate of hydrolysis of the titanium alkoxide is faster, it is necessary to control the synthesis process carefully to obtain mono-disperse nano-sized titania particles.

In the stabilization mechanism of nano-sized colloids in a solution, the interacting forces among the colloids affect the agglomeration/dispersion of the solution. The main factor for causing an agglomeration of colloids is the van der Waals force. To obtain stable colloids, it is necessary to balance the attractive force by the repulsions induced by surface electric charges of the colloid particles.

If a solid substance is put into a polar solution, the substance will go through reactions, such as ionization, ion adsorption, and ion dissolution in a solution, which provides a simple electron transfer or an adsorption of charged ions (e.g. long-chain poly-molecules) to produce surface electric charges. These surface electric charges will re-distribute the ionic concentration in adjacent media. In other words, the charged ions with an opposite charge of the surface are attracted to the surface of the particles, and the ions with the same electric charge are repelled from the surface. Further, the effect of Brownian motion increases the chance of adsorbing the ions of an opposite charge onto the particle surface, so as to produce an adsorbing layer on the particle surface. By then, only ions having the same electric charge with the surface will remain in the medium. To maintain an electric neutrality, opposite electric charges will disperse in the medium to produce a diffused layer in decreasing concentration adjacent to the adsorbing layer, so as to produce a so-called charge distribution of an electric double layer.

According to the DLVO theory, the stability of a colloidal solution is interpreted by the relation of the interacting potential energy and distance between colloidal particles. The energy is the sum of the van der Waals attraction and the repulsion of the electric charges caused by the overlapping of the electric layers. If the size of colloidal particles is constant, the van der Waals force varies with distance in inverse power, and the repulsion of electric charges is an exponential function of distance, as the particles are close with each other, a maximal energy barrier will occur, and its magnitude will be affected by the repulsion of electric charges. Therefore, if the colloidal surface has a high potential, the energy barrier will be increased and thus the particles excited by thermal energy cannot exceed such energy barrier, and the colloidal particles can be maintained stable by the net repulsion of the interacting effect. The major factors affecting the stability include the magnitude of surface potential, the thickness of electric double layer (also affected by the strength of ionization and concentration of electrolytes), and the system temperature.

In the article “Heterocoagulation in ionically stabilized mixed oxide colloidal dispersion in ethanol” by Wang and Nicholson (J. Am. Ceram. Soc., 84[6] 1250-56(2001)), the study of two kinds of oxides in a solution producing a heterogeneous coagulation is given, and the method adjusts the pH value within the range between the iso-electric points of the two oxides. In such pH range, an oxide surface carries positive electric charges and the other oxide surface carries negative electric charges. The attraction between the positive and negative static charges at the surfaces produces coagulation for the two kinds of particles. In the report by Wang and Nicholson, micron and submicron oxide particles were used and the effects of static charges and van der Waals force were taken into consideration only. Such core-shell structure produced by the positive and negative charged particle surfaces was also disclosed in U.S. Pat. Publication No. 20050014851 filed by Bringley in Jul. 18, 2003.

The van der Waals attraction is a force related to the distance between particles, the kinds of materials, and the particle diameter. If two same kinds of ceramic particles exist in a solution medium such as an aqueous solution or an alcohol solution, these two particles will be attracted to each other due to the van der Waals attraction. If these two kinds of ceramic particles exist in a specific solution or medium such as different liquids, the dielectric constant and Hamaker constant of the ceramic will differ from those of aqueous solution, and thus the magnitude of van der Waals force will vary greatly. Since the van der Waals force varies according to the ceramic particles, therefore if two particles are very tiny, the van der Waals attraction will become significant, and such theory also applies to attractions similar to the Brownian motion. In the research of [J. F. Li, C. T. Yang, B. Y. Yu, C. S. Chen and W. J. Wei, “Modeling motion and interaction of nanosized bimodal colloids with discrete element method,” IUMRS-ICA 2004 meeting, Shin-Chu, Taiwan, 10/2004], the relation between the Brownian motion and the diameter of colloidal particles is disclosed. If the particle diameter of a ceramic oxide (such as silica) is smaller than 100 nanometers, the effect of Brownian motion will be much greater than the static charge attraction, and also greater than the effect of viscous forces. Therefore, if the ceramic particle is smaller than 100 nanometers, we must pay attention to the effect of Brownian motion.

The methods for preparing composite particles having a coated layer have been reported in many literatures. The first kind of methods adopts a reduction of metal phase, such as nickel in a solution [Chen, Yu-Han “Preparation of Nano-Al₂0₃/Ni core-shell structured composite powder”, Master Thesis of National Taipei University of Technology, June, 2005], which coats a gold or silver material on the surface of particles, or a sol-gel reaction is used to coat silica on hematite particles as disclosed in [M. Ohmori and E. Matijevic, “Preparation and properties of uniform coated colloidal particles: silica on hematite,” J. Colloid and Interface Sci., 160[2] (1992) 288-292], or gold particles are coated on the surface as disclosed in [L. M. Liz-Marzan, M. Giersig, P. Mulvaney, “Synthesis of nanosized gold-silica core-shell particles, Langmuir, 12[18] (1996) 4329-4335].

In the literatures relating to the second kind of coating method, various different surfactants with hydrophilic radicals and hydrophobic radicals help coating nano-particles onto a heterogeneous substrate as disclosed in U.S. Pat. No. 6,573,313 by Li, et al. in 2003, and different functional radicals such as ethylene polymers are used to composite core-shell structured polymer particles. For example, U.S. Pat. Publication No. 20030143414 by Bendix et al., claimed “Aqueous primary dispersions and coating agents, methods for producing them and their use.”

The emulsified particles are used to control the interface reaction and connect the emulsified particle interfaces after a monomer reaction to produce core-shell particles having a diameter approximately equal to 500 nm. In the recent literatures written by Caruso (J. Am. Chem. Soc., 1998, 120, 8523-8524; Ad. Mat., 2000, 12, 333-337 and 2001, 12, 1090-1094, and 2002, 14, 508-512, and 2002, 14, 732-736; Langmuir 1999, 15, 8276-8281 and 2002, 18, 4150-4154; J. Magnetism Magnetic Mat., 2002, 240, 44-46; Colloids and Surfaces, A. Physicochemical and Eng. Aspects, 169 (2000) 287-293), similar methods are used to produce a film on the particle surface.

The third kind of the coating method is represented by U.S. Pat. Publication No. 20050014851 filed by Bringley, and the method uses two kinds of suspended colloids carrying different surface electric properties, and the value of surface potential exceeds 30 mV. Under the high-shear stirring, core-shell structured particles can be produced in a few seconds.

However, the nano-sized titania layer coated on a silica surface by the foregoing coating methods cannot give a uniform thickness, or most nano-sized titania particles produced on the silica surface are in an agglomerated form.

Therefore, the present invention provides a layer of nano-particles composed of photonic bandgap crystals for preventing an agglomeration of nano-particles by the effects of Brownian motion and van der Waals force and controlling the nano-particles to be adsorbed on the coated layer of submicron ceramic oxide particles, and thus the invention can uniformly coat nano-sized titania on the surface of silica particles.

### SUMMARY OF THE INVENTION

To solve the foregoing shortcomings of the prior art, it is a primary objective of the present invention to provide a method for coating a nano-sized layer on the surface of photonic bandgap crystals composed of tiny particles to avoid the agglomeration of nano-particles by the effects of Brownian motion and van der Waals force, and control nano-particles to be adsorbed on the coated layer of submicron ceramic oxide particles, so as to uniformly coat a nano-sized titania on the surface of silica particles.

Another objective of the present invention is to provide a method of coating a titania layer on the surface of photonic bandgap crystals consisted of SiO₂ particles to avoid the agglomeration of nano-particles by the effects of Brownian motion and van der Waals force and control nano-particles to be adsorbed on the coated layer of submicron ceramic oxide particles, so as to uniformly coat nano-sized titania on the surface of silica particles.

To achieve the foregoing objectives, a method for coating a nano-sized layer on the surface of photonic bandgap crystals composed of tiny particles of the present invention comprises the steps of: using a concentrated titanium alkoxide as a precursor; producing a source reagent of titania by the water molecules produced after an esterification under the condition of a controlled concentration; uniformly coating a nano-sized titania layer onto a mono-disperse silica surface; and calcinating composite particles of the coated layer to obtain the composite particles with a nano-particle layer.

To achieve the foregoing objectives, a method for coating a nano-sized layer on the surface of photonic bandgap crystals composed of tiny particles in accordance with the invention comprises the steps of: putting photonic bandgap crystals assembled by silica particles in a source reacting solution of an aqueous solution of titania to carry out a vacuum adsorbing process; uniformly attaching a colloidal particle suspension of titania on the surface of silica; and drying after said calcination to produce a nano-sized titania layer on said silica particle.

To make it easier for our examiner to understand the objective, characteristics and performance of the present invention, the following embodiments accompanied with the related drawings are described in details.

### BRIEF DESCRIPTION OF THE DRAWINGS

FIG. 1 is a flow chart of a method of coating a nano-sized layer on the surface of photonic bandgap crystals composed of tiny particles according to a preferred embodiment of the present invention;

FIG. 2 is a flow chart of a method of coating a titania layer onto photonic bandgap crystals composed of aligned silica particles according to another preferred embodiment of the present invention.

### DETAILED DESCRIPTION OF THE PREFERRED EMBODIMENTS

Before a nano-sized titania layer is coated onto the surface of silica, it is necessary to prepare mono-size silica particles and mono-size titania particles. In the present invention, Stöber's method is adopted to produce mono-size silica particles. In the method, a pure tetra-ethyl orthosilicate (TEOS, MERCK-Schuchardt, Germany) is used as a reactant, and ammonium hydroxide (28-30 wt % solution of NH₃ in water, ACROS ORGANICS, USA) is used as a catalyst. Alcohol (extra pure reagent, either 95% or 99.5%, Shimakyu Pure Chemicals, Japan) and deionized water are used as solvents. Refer to U.S. Pat. No. 6,653,356 entitled “Nanoparticulate titanium dioxide coatings, and processes for the production and use thereof” and issued to J. Sherman in 2003 for the detailed procedure of synthesizing silica. The synthesized silica particles are dispersed in the alcohol or dried at room temperature, and then moved to an oven and dried at 105° C. for 24 hours. The silica deposits can be deposited in the silica suspension for 10 days to 14 days.

In the present invention, homogenous titania particles can be obtained by a slow reaction between titanium alkoxide and water, and thus the esterification of n-butanol and anhydrous acetic acid is used to control the rate of producing water molecules and further control the reaction rate of titanium alkoxide with water. Firstly, 0.02 mol of titanium alkoxide (titanium (IV) n-butoxide, TBOT MW=340.35, ACROS ORGANICS, USA) is added into the 0.08 mol n-butanol (n-butanol, L. C. Grade, Alps Chemical Co., Ltd.), and 0.02 mol of anhydrous acetic acid (anhydrous acetic acid, L. C. Grade, Alps Chemical Co., Ltd.) triggers the reaction of producing water molecules, which react with titanium alkoxide. The synthesizing conditions of this reaction are controlled at a temperature of 25° C. and a relative humidity of 55% and stirred with magnets for 8 hours. The composed titania particles are dried at room temperature, and then moved to an oven and dried at 105° C. for 24 hours. The calcination process is conducted at a temperature by rising to 150° C. at a rate of 3° C./min and held for an hour, and then rising to 500° C. at the rate of 5° C./min and held for 30 minutes. The composed titania are dried and calcinated to obtain an anatase phase.

In an aqueous solution, the iso-electric point of silica is at pH=2.3, and the iso-electric point of titania is at pH=4.5. In an alcohol solution, the quantity of electric charges from the two particle surfaces drops to approximately 10 mV, and the iso-electric point shifts towards alkalinity, and the iso-electric point of silica is at pH=3.8, and the iso-electric point of titania is at pH=6.0.

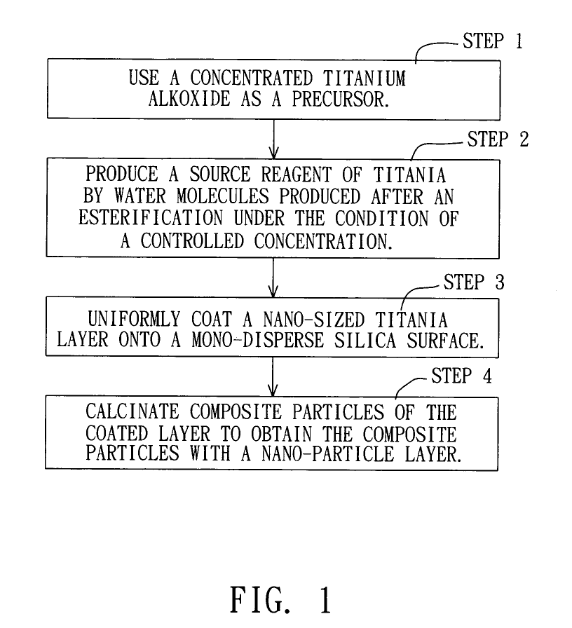

Referring to FIG. 1 for the flow chart of a method of coating a nano-sized layer on the surface of photonic bandgap crystals composed of tiny particles according to a preferred embodiment of the present invention, the method prepares the mono-size silica particles and titania particles, and then coats the titania particles uniformly on the silica particles according to the following procedure. In FIG. 1, the method of coating a nano-sized layer onto the surface of the photonic bandgap crystals composed of tiny particles can prevent an agglomeration of nano-particles by the effects of Brownian motion and van der Waals force, and control the nano-particles to be adsorbed onto the tiny ceramic oxide particles, so as to uniformly coated nano-sized oxide colloids onto the surface of silica particles and make its thickness even. After the composite particles are coated and processed in the calcination, composite particles having a uniform layer of nano-particles are obtained and used for photonic bandgap crystals. The method comprises the steps of: using a concentrated titanium alkoxide as a precursor (Step 1); producing a source reagent of titania by the water molecules produced after an esterification under the condition of a controlled concentration (Step 2); uniformly coating a nano-sized titania layer onto a mono-disperse silica surface (Step 3); and calcinating composite particles of the coated layer to obtain the composite particles with a nano-particle layer (Step 4), wherein the method of coating a layer is conducted in an aqueous solution with 0.1-99% of water, and the mixed aqueous solution contains 0.1-90% alcohol and 0.1-30% alkoxide.

In Step 2, the water molecules produced by controlling a specific concentration and esterification reaction are used as a source reagent, and the concentration of the titanium alkoxide is substantially less then 2.0%.

In Step 3, the nano-sized titania layer is coated uniformly on the surface of the mono-disperse silica, wherein the thickness of obtained titania layer ranges from five nanometers to tens of nanometers.

In Step 4, the composite particles of the coated layer is calcinated to obtain the composite particles with a uniform nano-particle layer, wherein the temperature of the calcination is approximately below 1000° C. for removing water and organic matters.

Therefore, the composite particles produced according to the foregoing method have the following advantages: 1. Although the surface potential of the coated particle is different from that of the core particle, the surface potential needs not to exceed 30 mV, which is different from the requirements of the U.S. Pat. Application No. 20050014851 filed by Bringley. 2. The composite particles can be produced continuously. In the aforementioned particle synthesis process, a new Stöber silica particle is added, so that this colloidal particle can produce a reaction in the nano-particle synthesizing tank and these tiny agglomerated particles will be separated at the outlet, and thus a nano-sized layer can be coated uniformly on the surface of the agglomerated particles. 3. Many kinds of ceramics can be coated. 4. Many kinds of ceramics can be coated onto other ceramic particles, particularly for the coating layer and substrate made of different materials. Only if there are two different oxides, this method can be used for coating a layer. Therefore, the method of coating a layer on composite particles of the invention definitely can overcome the foregoing shortcomings of the prior art.

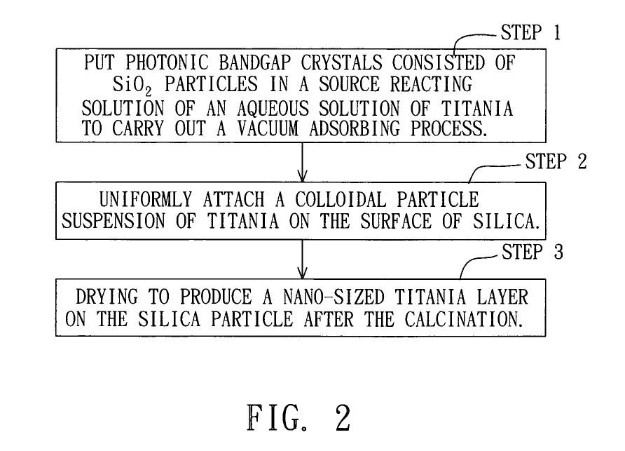

Referring to FIG. 2 for the flow chart of a method for coating a titania layer onto photonic bandgap crystals composed of aligned silica particles according to another preferred embodiment of the present invention, the method comprises the steps of: putting photonic bandgap crystals consisted of SiO₂ particles in a source reacting solution of an aqueous solution of titania to carry out a vacuum adsorbing process (Step 1); uniformly attaching a colloidal particle suspension of titania on the surface of silica (Step 2); and drying after said calcination to produce a nano-sized titania layer on said silica particle (Step 3).

In Step 1, the source reacting solution of titania adopts a concentrated titanium alkoxide as a precursor, and the water molecules produced by controlling a specific concentration and esterfied are reacted to produce a source reagent of titania, and the specific concentration of the titanium alkoxide is substantially less then 2.0%.

In Step 2, the colloidal particle suspension of titania is attached uniformly on the surface of silica, wherein the thickness of the coated titania layer substantially ranges from five nanometers to tens of nanometers.

In Step 3, the silica is dried to produce a nano-sized titania layer on said silica particle after the calcination, wherein the temperature of calcination is below 1000° C. for removing water and organic matters and sintering a small quantity of silica particles to provide a strength for a sintered body.

Therefore, the method for coating a nano-sized layer on the surface of photonic bandgap crystals composed of tiny particles in accordance with the present invention uniformly coats the titania particles onto the silica particles, and also has the following advantages: 1. A water-base or solvent-base process is used, and thus the cost is much lower than the gas phase process (such as CVD and EMD). 2. The manufacturing process does not require a surface polymer modifier, so as to save the expensive modification cost. 3. The method for adopting this nano-size layer technology is simple and easy, but it requires a strict control procedure. After the material of the oxide particle surface is changed to titania, the properties (electrical and optical properties) are improved significantly. 4. The nano-sized layer can be applied onto the silica photonic bandgap crystals.

With the practice of the present invention, the agglomeration of nano-particles can be avoided by the effects of Brownian motion and van der Waals force, and the nano-particles can be controlled and adsorbed on the coated layer of submicron ceramic oxide particles, so that the nano-sized titania can be coated uniformly on the surface of the silica particles. This method is conducted in an aqueous solution, and the thickness of the obtained coated layer can be controlled within the range from five nanometers to tens of nanometers, and the thickness is uniform. After the composite particles are coated and calcinated, the composite particles having a uniform nano-particle surface can be obtained, and composed into the photonic bandgap crystals. Therefore, the present invention can overcome the shortcomings of the prior art.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional coating process and further complies with the patent application requirements and is submitted to the Patent and Trademark Office for review and granting of the commensurate patent rights.

What is claimed is:

1. A method for coating a nano-sized layer on the surface of photonic bandgap crystals composed of tiny particles, comprising the steps of:
using a concentrated titanium alkoxide as a precursor;
producing a source reagent of titania by water molecules produced after an esterification under the condition of a controlled concentration;
uniformly coating a nano-sized titania layer onto a mono-disperse silica surface; and
calcinating composite particles of said coated layer to obtain said composite particles with a nano-particle layer.

2. The method of claim 1, wherein said method is conducted in an aqueous solution containing 0.1% to 99% of water content.

3. The method of claim 2, wherein said aqueous solution contains 0.1% to 90% of alcohol and 0.1% to 30% of alkoxide content.

4. The method of claim 1, wherein said titanium alkoxide has a concentration substantially less than 2.0%.

5. The method of claim 1, wherein said titania coating layer has a thickness substantially ranging from five nanometers to tens of nanometers.

6. The method of claim 1, wherein said calcination is conducted at a temperature substantially below 1000 degrees Centigrade for removing moisture and organic matters.

7. A method for coating a titania layer on photonic bandgap crystals consisted of silica particles, comprising the steps of:
putting photonic bandgap crystals in a titania source regent solution to carry out a vacuum adsorbing process;
uniformly adsorbing a colloidal particle suspension of titania on the surface of silica; and
drying after said calcination to produce a nano-sized titania layer on said silica particles.

8. The method of claim 7, wherein said colloidal particle containing titanium-species in said aqueous solution has a content of less than 2.0%.

9. The method of claim 7, wherein said titania source reagent solution uses a concentrated titanium alkoxide as a precursor and a water molecule reaction produced by an esterification reaction.

10. The method of claim 9, wherein said titanium alkoxide has a concentration substantially less than 2.0%.

11. The method of claim 9, wherein said titania coating layer has a thickness substantially ranging from 5 nanometers to tens of nanometers.

12. The method of claim 9, wherein said calcination is conducted at a temperature substantially below 1000 degrees Centigrade for removing moisture and organic matters and slightly sintering of the silica particles in order to improve the strength of a sintered body.
